(19) United States
(12) Patent Application Publication
(10) Pub. No.: US 2008/0220269 A1
(43) Pub. Date: Sep. 11, 2008

(54) Camouflage material

(76) Inventor: Jean Dumas, Pintendre (CA)

Correspondence Address: George A. Seaby;Seaby & Associates, 603 - 250 City Centre Ave., Ottawa, ON, K1R 6K7, CA

(21) Appl. No.: 11/714,107

(22) Filed: Mar. 6, 2007

(51) Int. Cl. B32B 15/08; B05D 3/00

(52) U.S. Cl. 428/458; 427/191

(57) ABSTRACT

A camouflage material for use in a snowy environment includes a laminated, extruded polyethylene sheet; an aluminum coating on one surface of the sheet and a layer of nylon on the other surface of the sheet. The resulting white material is reflective to radar and to thermal properties which are very similar to the infrared characteristics of background snow.

### BACKGROUND OF THE INVENTION

This invention relates to a camouflage material, and in particular to a camouflage material for use in a snowy environment.

1. Field of the Invention

The surveillance capabilities of armed forces around the world have increased considerably in recent years. The threat to military objectives is multi-spectral, and only camouflage, concealment and deception (CCD) can provide a sufficient level of protection in the appropriate electromagnetic spectral bands. Over the last few years, advances in sensor technology have led to the development of systems with enhanced electromagnetic spectral coverage and performance at competitive costs. From a military standpoint, these advanced technologies make it harder to go undetected on the battlefield. Developing new camouflage material with multi-spectral signature-reduction capabilities is an effective way to increase the chances of survival on the modern battlefield.

2. Discussion of the Prior Art

Northern portions of North America are covered with snow for much of the year. Conventional camouflage nets of the type used in temperate forest regions or in the prairie regions are ineffective. Low temperatures and snow, which often covers much of the vegetation, completely alter the background behavior, rendering conventional camouflage materials ineffective. Early generations of camouflage nets for snow environments were composed of polyvinyl chloride (PVC) in woven fabric form. Such nets are effective in the visible spectral band because they are white, and in the near-infrared band exploited by image intensifiers. But despite their low cost and high durability, PVC fabrics are virtually transparent to infrared thermal sensors and radar, making any heat source readily detectable to IR imagers and radar. In the 1990s, a new generation of camouflage net was developed based on laminated, extruded polyethylene, better known by the trade-mark TYVEK. The material was developed in Germany, and especially by Saab-Barracuda of Sweden, and includes a TYVEK sheet with an aluminum film vacuum-bonded to one surface thereof. Another sheet of TYVEK printed in a special shadow pattern is quilted to the aluminum film to reduce the inherent gloss of the TYVEK. The result is a flexible sheet that is completely white on one surface and patterned on the other surface. Due to the quilting process, the sheets are quite costly to manufacture. Moreover, printing the camouflage pattern on the TYVEK requires a special process that is fairly complex and costly. In terms of performance, the sheets are effective in reducing the signature in the visible, near-IR and radar spectral bands, as well as the thermal signature of the product within limitations. In the thermal band of radiation, the material is often too reflective or not reflective enough, depending on the situation, which can make it detectable to thermal imagers.

### GENERAL DESCRIPTION OF THE INVENTION

The object of the present invention is to provide a winter camouflage material, which is relatively inexpensive to produce, and which has a good camouflage performance in several electromagnetic spectral bands.

Accordingly, the invention relates to a camouflage material for use in a snowy environment comprising a laminated, extruded polyethylene sheet; an aluminum coating on one surface of the polyethylene sheet sufficient to make the sheet reflective to radar and thermal radiation; and a layer of nylon on a second surface of the polyethylene sheet sufficient to increase the thermal reflectance of the material.

### Description of the Preferred Embodiment

The invention is described below in greater detail with reference to a specific, non-limiting example of a camouflage material.

In accordance with the invention, various materials were applied to TYVEK to optimize its camouflage performance in several spectral bands. In particular, the invention is the result of research on signature reduction of artic tents in the thermal spectral band with stoves operating in the tents.

The primary consideration in designing camouflage material for a snow environment is to maintain a flat white color as much as possible with a finish that is durable and washable. Using a continuous-vacuum deposition process, a thin (a thickness of up to approximately 8 mil) coating of aluminum was deposited on one side of a TYVEK sheet to make it reflective to radar and the thermal band of radiation, specifically in the 8-12 micron wavelength band. The resulting aluminum-coated TYVEK was too reflective in the 3-5 micron IR wavelength band, and accordingly a thin layer of spun-bonded, extruded nylon 6.6 was applied to the untreated surface of the TYVEK in an amount of about 0.5 ounce per square yard, thereby reducing the thermal signature of the material without altering its other properties. Laminating the aluminized TYVEK with thin, extruded nylon using hot-melted, ultraviolet-sensitive, polyurethane glue in an amount of about five grams per square meter yielded a material with highly effective surface properties. The characteristic gloss of the TYVEK is considerably reduced and its visible and near-IR reflectance are excellent against a background of snow. The most impressive property of the material is its surface reflectance in the thermal band. Three material samples were exposed to sunlight against a snow background and their thermal signatures were measured. A standard aluminized TYVEK sample was clearly too cold. The other two samples, which were coated with extruded nylon, exhibited a signature in the 8-12 micron band comparable to that of the snow background. In the 3-5 micron band, the non-laminated TYVEK is far more reflective than the snow, rendering it detectable in sunny conditions. On the other hand the nylon-laminated TYVEK exhibits a less prominent signature and better blends with a background of snow. The material performs better than previously existing materials, and improves the level of protection and chances of survival of military assets in winter conditions with snow. The laminating process is far less costly than quilting, and a substantial reduction in basic material costs is expected.

The material described above is ideal for making camouflage uniforms for the military. The material is thin, flexible and strong enough for use as a uniform fabric. Moreover, the material could be used to make large camouflage nets to reduce the signatures of tents and vehicle. By laminating a thicker layer (1-1.5 ounces per square yard) of extruded nylon to the back of aluminized TYVEK, it is possible to produce a very strong fabric that can be used to make nets. Moreover, it is easy to print a shadow camouflage pattern (like that used on existing camouflage nets) at far lower cost than if the pattern was printed directly on TYVEK. The strength and abrasion resistance of the material are comparable to, if not better than, currently available products, and the material is similar to or lighter in weight than such products.

1. A camouflage material for use in a snowy environment comprising a laminated, extruded polyethylene sheet; an aluminum coating on one surface of the polyethylene sheet sufficient to make the sheet reflective to radar and thermal radiation; and a layer of nylon on a second surface of the polyethylene sheet sufficient to increase the thermal reflectance of the material.

2. The camouflage material of claim 1, wherein the aluminum coating is sufficiently thick to make the material reflective to electromagnetic radiation having a wavelength of 8-12 microns.

3. The camouflage material of claim 2, wherein the nylon layer is sufficiently thick to make the material reflective to electromagnetic radiation having a wavelength of 3-5 microns.

4. The camouflage material of claim 1, wherein the nylon is extruded, spun-bonded nylon 6.6

5. The camouflage material of claim 4, wherein the aluminum coating has a thickness of up to 8 mils.

6. A method of producing a camouflage material for use in a snowy environment comprising the steps of coating one surface of a laminated, extruded polyethylene sheet with aluminum sufficient to make the sheet reflective to radar and thermal radiation; and coating a second surface of the polyethylene sheet with a layer of nylon sufficient to increase the thermal reflectance of the material.

7. The method of claim 6, wherein sufficient aluminum is used to make the material reflective to electromagnetic radiation having a wavelength of 8-12 microns.

8. The method of claim 7, wherein sufficient nylon is used to make the material reflective to electromagnetic radiation having a wavelength of 3-5 microns.

9. The method of claim 7, wherein the nylon is extruded, spun-bonded nylon 6.6 and is applied to the polyethylene sheet in an amount of 0.5 ounce per square yard.

10. The method of claim 9, wherein the aluminum is coated to the polyethylene sheet in an amount sufficient to form coating having a thickness of up to 8 mils.

11. The method of claim 10, wherein the aluminum coating on the polyethylene sheet is formed by vacuum deposition.
